(19) United States
(12) Patent Application Publication
(10) Pub. No.: US 2011/0285630 A1
(43) Pub. Date: Nov. 24, 2011

(54) ELECTRONIC APPARATUS

(75) Inventors: Yusuke Sugiura, Ome-shi (JP); Makoto Tanaka, Ome-shi (JP)

(73) Assignee: KABUSHIKI KAISHA TOSHIBA, Tokyo (JP)

(21) Appl. No.: 13/086,653

(22) Filed: Apr. 14, 2011

(30) Foreign Application Priority Data
May 21, 2010 (JP) 2010-117601

(51) Int. Cl. G06F 3/02

(52) U.S. Cl. 345/168

(57) ABSTRACT

According to one embodiment, an electronic apparatus includes a housing including a palmrest, a keyboard on the housing including a space key and a cursor key closer to the palmrest than the space and a switch in a region of the keyboard surrounded by the space key, the cursor key, and the palmrest

### CROSS-REFERENCE TO RELATED APPLICATIONS

This application is based upon and claims the benefit of priority from Japanese Patent Application No 2010-117601, filed May 21, 2010; the entire contents of which are incorporated herein by reference.

### FIELD

Embodiments described herein relate generally to an electronic apparatus including a keyboard.

### BACKGROUND

For example, electronic apparatuses, such as notebook personal computers (hereinafter, referred to as notebook PCs) include keyboards. The keyboard includes a space key and cursor keys closer to a palmrest than the space key. The keyboard has an outward form in which the periphery of the cursor key protrudes toward the palmrest in a convex shape.

### BRIEF DESCRIPTION OF THE DRAWINGS

A general architecture that implements the various features of the embodiments will now be described with reference to the drawings, The drawings and the associated descriptions are provided to illustrate the embodiments and not to limit the scope of the invention.

FIG. 1 is an example perspective view illustrating an example of an electronic apparatus according to a first embodiment;

FIG. 2 is an example plan view illustrating an example of a main unit of the electronic apparatus shown in FIG. 1;

FIG. 3 is an example perspective view illustrating an example of a button for turning on or off a touchpad shown in FIG. 1;

FIG. 4 is an example plan view illustrating an example of a membrane of a keyboard of the electronic apparatus shown in FIG. 1;

FIG. 5 is an example enlarged perspective view illustrating an example of a switch shown in FIG. 4;

FIG. 6 is an example plan view illustrating an example of a lower surface of the membrane shown in FIG. 4;

FIG. 7 is an example plan view illustrating an example of a wiring pattern of the membrane shown in FIG. 6;

FIG. 8 is an example cross-sectional view illustrating the keyboard taken along the line C1-C2 of FIG. 2; and

FIG. 9 is an example plan view illustrating an example of a wiring pattern of a membrane according to a second embodiment,

### DETAILED DESCRIPTION

Various embodiments will be described hereinafter with reference to the accompanying drawings.

In general, according to one embodiment, an electronic apparatus comprises a housing comprising a palmrest, a keyboard on the housing comprising a space key and a cursor key closer to the palmrest than the space key, and a switch in a region of the keyboard surrounded by the space key, the cursor key, and the palmrest.

Hereinafter, example embodiments will be described with reference to the accompanying drawings.

### First Embodiment

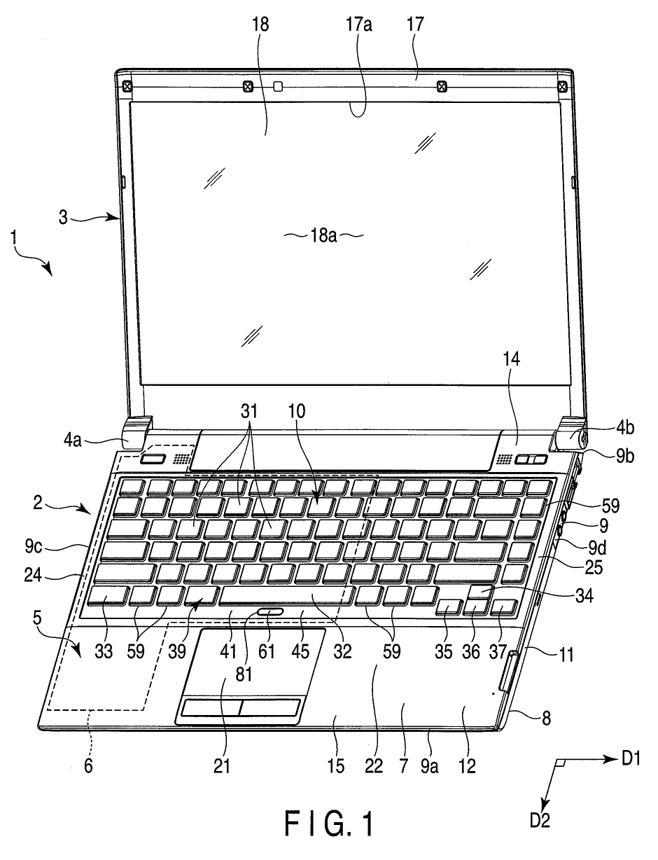

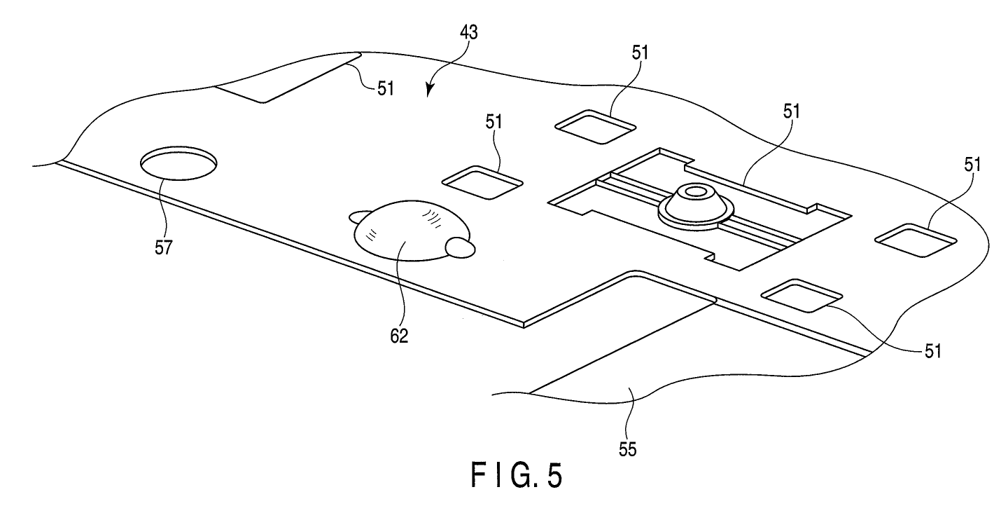

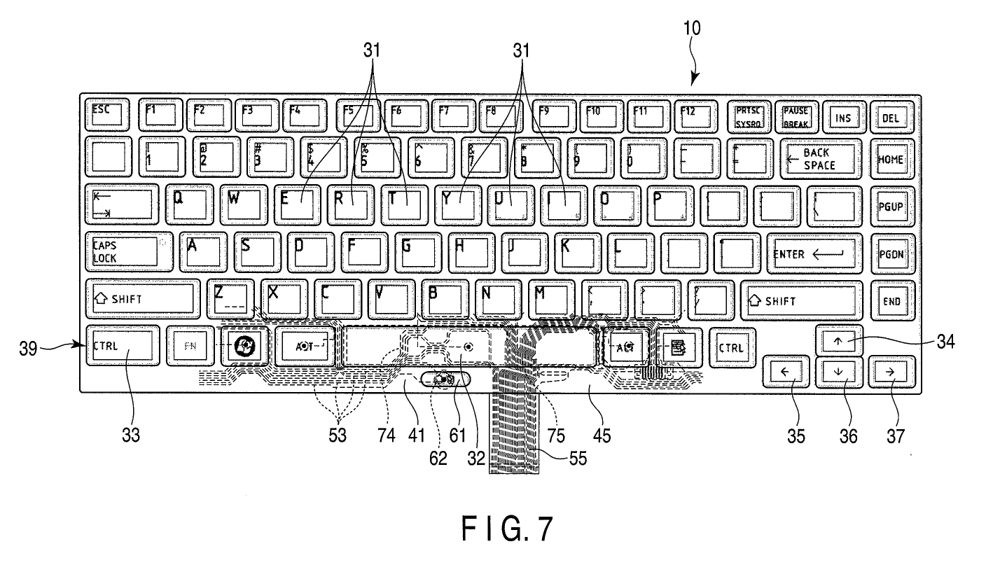

FIGS. 1 to 8 show an electronic apparatus 1 according to a first embodiment. The electronic apparatus 1 is, for example, a notebook PC. However, electronic apparatuses to which the embodiment can be applied are not limited thereto. The embodiment can he widely applied to various kinds of electronic apparatuses including a PDA (Personal Digital Assistant) and a game machine.

As shown in FIG. 1, the electronic apparatus 1 includes a main unit 2, a display unit 3, and hinges 4a and 4b. The main unit 2 is an electronic apparatus main body. The main unit 2 includes a housing S. The housing 5 includes a main board 6. The housing 5 has a flat box shape including an upper wall 7, a lower wall 8, and a circumferential wall 9.

The lower wall 8 faces a desk surface when the electronic apparatus 1 is placed on a desk. The lower wall 8 is substantially parallel to the desk surface. The upper wall 7 is opposite to the lower wall 8 with a space therebetween and extends substantially in parallel (that is, substantially in a horizontal direction) to the lower wall 8. A keyboard 10 is provided on the upper wall 7. The circumferential wall 9 rises with respect to the lower wall 8, and connects the edge portion of the lower wail 8 and the edge portion of the upper.' wall 7.

The housing 5 includes a housing base 11 and a housing cover 12. The housing base 11 includes the lower wall 8 and a part of the circumferential wall 9 The housing cover 12 includes the upper wall 7 and a part of the circumferential wall 9. The housing cover 12 is combined with the housing base 11 to form the housing 5.

The housing 5 includes a rear end portion 14 to which the display unit 3 is rotatably connected and a front end portion 15 opposite to the rear end portion 14, The circumferential wall 9 includes a front wall 9a, a rear wall 9b, a left wall 9c, and a right wall 9d. The front wall 9a extends in the width direction (left-right direction) of the housing 5 at the front end portion 15, The rear wall 9b extends in the width direction of the housing 5 at the rear end portion 14. The left wall 9c and the right wall 9d extend in the depth direction (front-rear direction) of the housing 5 and connect the end portion of the front wall 9a and the end portion of the rear wall 9b.

The display unit 3 is rotatably (openably) connected to the rear end portion 14 of the main unit 2 by the hinges 4a and 4b. The display unit 3 can be pivoted between a closed position where the display unit 3 descends and covers the main unit 2 from the upper side and an opened position where the display unit 3 rises with respect to the main unit 2.

As shown in FIG. 1, the display unit 3 includes a display housing 17 and a display panel 18 in the display housing 17. A display screen 18a of the display panel 18 can be exposed to the outside through an opening portion 17a in the front wall of the display housing 17.

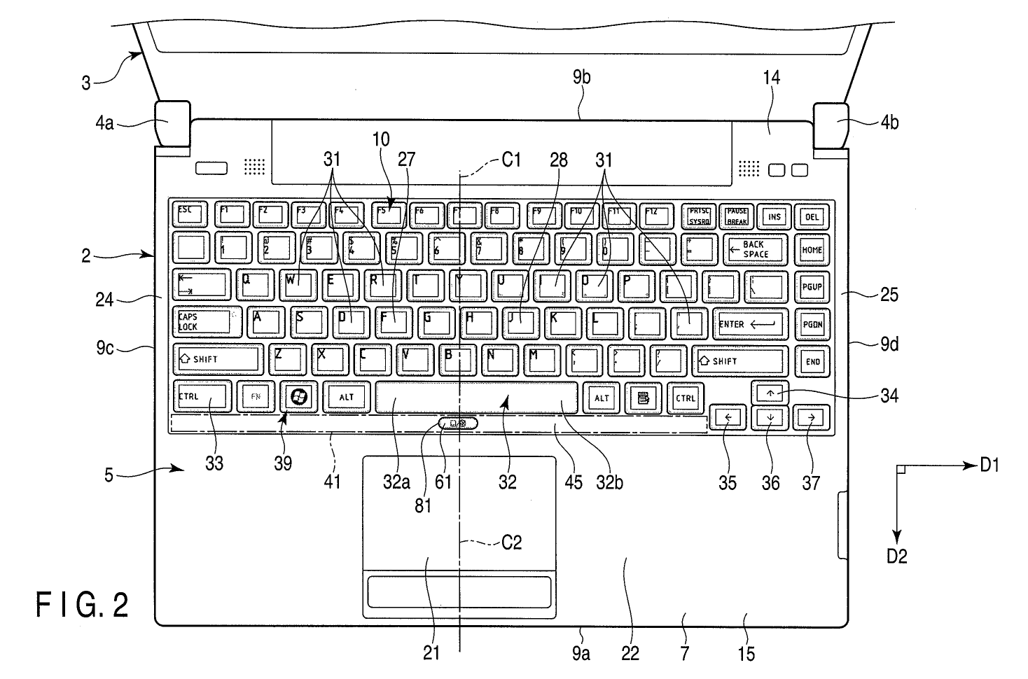

As shown in FIGS. 1 and 2, the keyboard 10, a touchpad 21, and a palmrest 22 are provided on the upper wall 7, The keyboard 10 extends substantially in parallel to the front wall 9a in the width direction of the housing 5 between the left wall 9c and the right wall 9d.

As shown in FIGS, 1 and 2, the housing 5 includes a first end portion 24 and a second end portion 25 in the longitudinal direction (the width direction) of the housing 5. The first end portion 24 includes, for example, the left wall 9c. The second end portion 25 includes, for example, the right wall 9d.

As shown in FIG. 2, a home position center C1 of the keyboard 10 is closer to the first end portion 24 than to the second end portion 25 from the center of the housing 5 (housing center)a The term “home position” means a position where the forefingers of the left and right hands of the user are placed on an F key 27 and a J key 28, which are reference keys, on a JIS keyboard or an ASCII keyboard. The term “home position center” means a line that traverses the center between the F key 27 and the J key 28 in the lateral direction of the keyboard 10.

The touchpad 21 is an example of a module of the electronic apparatus 1. The touchpad 21 is electrically connected to the main board 6. The touchpad 21 is between the keyboard 10 and the front wall 9a. The touchpad 21 is provided so as to correspond to the home position center C1 of the keyboard 10. That is, a touchpad center C2 of the touchpad 21 is aligned with the home position center C1 of the keyboard 10.

Therefore, the touchpad 21 deviates from the center of the housing 5 and is close to the first end portion 24 than to the second end portion 25, The term “touchpad center” means a line that traverses the center of the touchpad in the lateral direction of the keyboard 10.

For example, hands of the user are placed on the palmrest 22 when the user operates the keyboard 10 The palmrest 22 is substantially in the entire region between the keyboard 10 and the front wall 9a except for the touchpad 21 and the buttons attached to the touchpad 21 That is, the palmrest 22 is between the first end portion 24 and the touchpad 21, between the second end portion 25 and the touchpad 21, and between the keyboard 10 and the touchpad 21.

Here, a first direction D1 and a second direction D2 are defined. The first direction D1 is the longitudinal direction of the keyboard 10. The second direction D2 is the lateral direction of the keyboard 10, is from the keyboard 10 to the touchpad 21, and is substantially orthogonal to the first direction D1.

As shown in FIGS. 1 and 2, the keyboard 10 has a substantially rectangular shape. Specifically, the keyboard 10 includes character keys 31 for inputting, for example, an alphabet, a space key 32, a control key 33, and four cursor keys 34, 35, 36, and 37. The space key 32 and the control key 33 are arranged in the first direction D1 to form a key row 39, which is the front row of the keyboard 10.

Among the four cursor keys 34, 35, 36, and 37, three cursor keys 35, 36, and 37 are closer to the palmrest 22 than the key row 39. That is, the cursor keys 35, 36, and 37 are closer to the palmrest 22 than the space key 32,

As shown in FIGS. 1 and 2, the keyboard 10 includes a flat portion 41 corresponding to a step between the space key 32 and the cursor keys 35, 36, and 37 protruding from the space key 32 to the palmrest 22. That is, the flat portion 41 is between the key row 39 including the space key 32 and the palmrest 22 (that is, between the space key 32 and the touchpad 21) on the side of the cursor key 35. In other words, the flat portion 41 is a region surrounded by the space key 32, the cursor key 35, and the palmrest 22 (or touchpad 21). In the specification, the term “the region surrounded” does not necessarily mean a region surrounded in all directions, but includes a region surrounded in three or two directions.

The flat portion 41 is formed so as to correspond to the step between the space key 32 and the cursor keys 35, 36, and 37. In this way, the front end portion (an end portion adjacent to the palmrest 22) of the keyboard 10 is formed in a straight line. That is, in the keyboard 10, the cursor keys 35, 36, and 37 do not protrude toward the palmrest 22 but the front end portion of the keyboard 10 is substantially parallel to the front wall 9a, The flat portion 41 may be referred to as, for example, a non-key-mounted portion, a margin portion, an extra portion, or a blank portion.

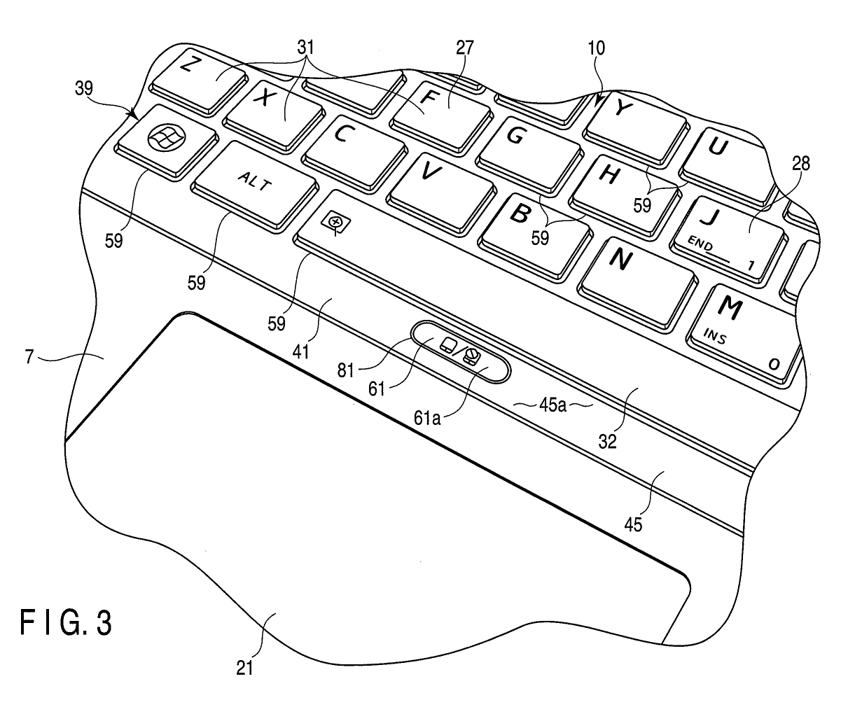

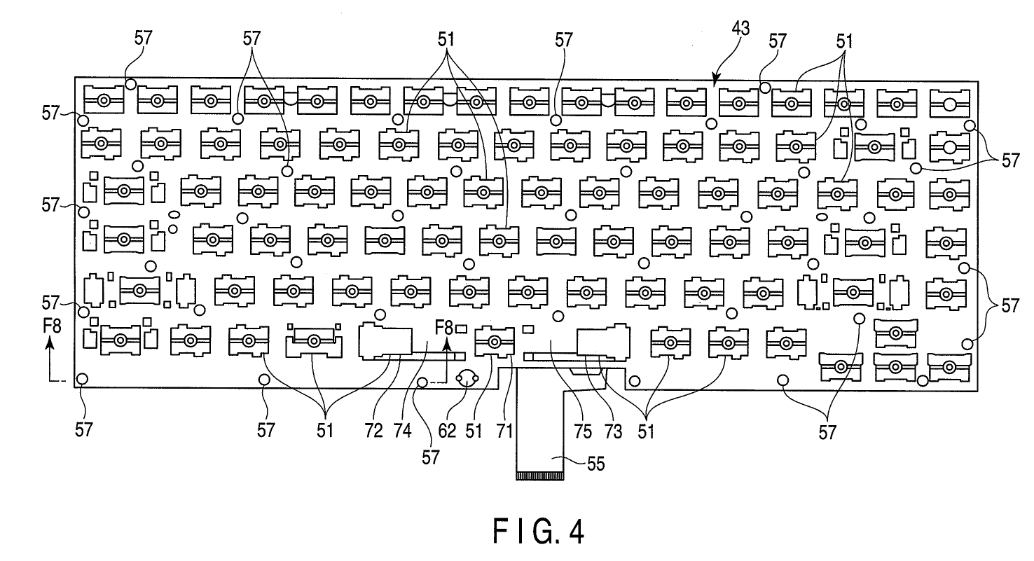

As shown in FIG. 3, the keyboard 10 is a tile keyboard. That is, the keyboard 10 includes a membrane 43 on which the keys 31, 32, 33, 34, 35, 36, and 37 are mounted, a metal plate 44, and a frame 45. FIG. 4 shows the upper surface of the membrane 43. The membrane 43 is a so-called membrane sheet and is a sheet having substantially the same size as the keyboard 10. That is, the membrane 43 extends from the keys 31, 32, 33, 34, 35, 36, and 37 to the flat portion 41.

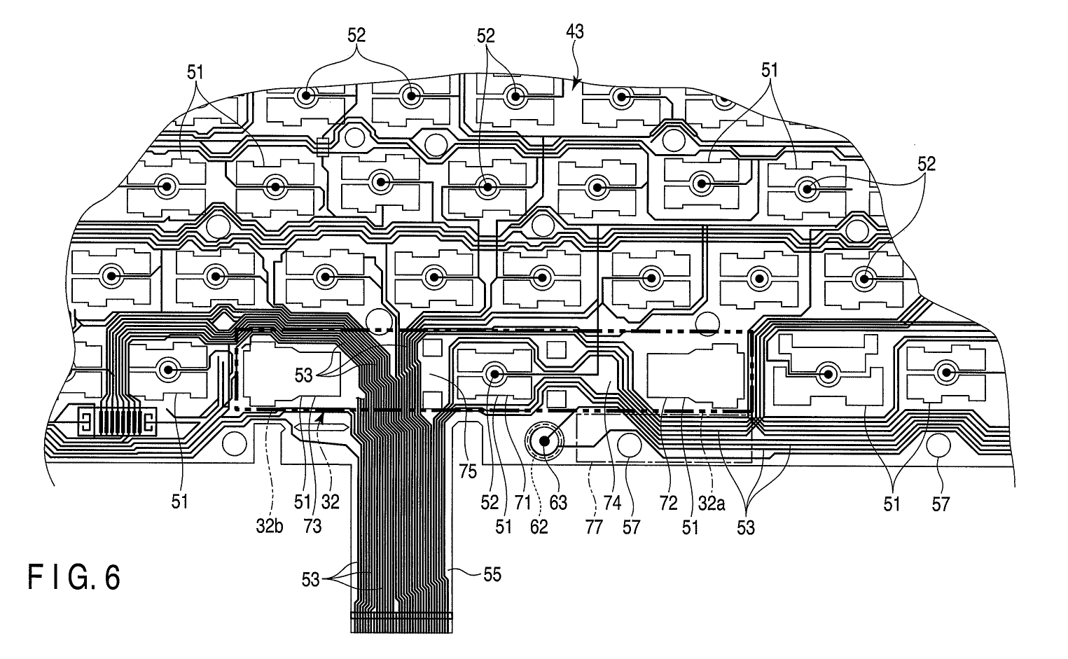

FIG. 6 shows the lower surface of the membrane 43. The membrane 43 includes opening portions 51, contacts 52, and wiring patterns 53. The opening portions 51 are below the keys 31, 32, 33, 34, 35, 36, and 37. For example, a supporting mechanism for supporting the keys 31, 32, 33, 34, 35, 36, and 37 is attached to the opening portions 51. The contacts 52 are in the opening portions 51 and correspond to the inputs of the keys 31, 32, 33, 34, 35, 36, and 37. The wiring patterns 53 connect the contacts 52.

The wiring patterns 53 are bundled into a Flexible Flat Cable (FFC) 55 at the front end portion of the keyboard 10. The FFC 55 is connected to the main board 6. The membrane 43 includes a plurality of fixing holes The keys 31, 32, 33, 34, 35, 36, and 37 are provided to correspond to the contacts 52 of the membrane 43 by a supporting mechanism (not shown) such that they can be moved forward to and backward from the contacts 52 of the membrane 43.

As shown in G. 8, the metal elate 44 covers the lower surface of the membrane 43. The metal plate 44 has substantially the same size as the keyboard 10 and ensures the rigidity of the keyboard 10. The metal plate 44 includes fixing holes 58 at positions corresponding to the holes 57 of the membrane

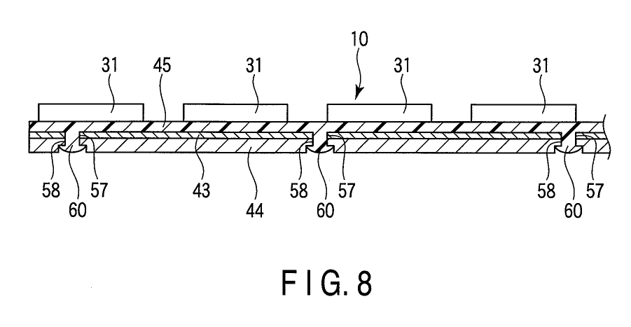

As shown in FIG. 3, the frame 45 is formed in a plate shape, covers the upper surface of the membrane 43, and includes opening portions 59 corresponding to the keys 31, 32, 33, 34, 35, 36, and 37. An upper surface 45a of the frame 45 is flat. As shown in FIG. 8, the frame 45 includes protrusions 60 inserted into the holes 57 of the membrane 43 and the holes 58 of the metal plate 44 and protruding toward the lower side of the metal plate 44. The leading end portions of the protrusions 60 are fused and fixed to the metal plate 44.

In this way, the frame 45, the membrane 43, and the metal plate 44 are integrated. Some of the protrusions 60 are provided in the flat portion 41 of the keyboard 10. That is, fixing portions that integrally fix the frame 45, the membrane 43, and the metal plate 44 are provided in the flat portion 41 of the keyboard 10.

In the specification, the “flat portion of the keyboard” indicates the region surrounded by the space key 32, the cursor key 35, and the palmrest 22 (or touchpad 21), but does not include only the frame 45, The “flat portion of the keyboard” includes each portion of the membrane 43, the metal plate 44, and the frame 45 in the surrounded region.

As shown in FIGS. 1 to 4, a button 61 and a switch 62 for controlling the function of the touchpad 21 are provided in the flat portion 41 of the keyboard 10. The button 61 is provided in the frame 45 of the keyboard 10. The switch 62 is mounted on the membrane 43 and below the button 61.

The switch 62 is electrically connected to the main board 6 and can control the touchpad 21, which will be described below, The switch 62 is for turning on or off the touchpad 21. The user can operate the switch 62 using the button 61 to switch the touchpad 21 between an on state in which an input is received and an off state in which no input is received.

The button 61 and the switch 62 are provided in a region adjacent to the space key 32 and between the space key 32 and the touchpad 21. Specifically, the button 61 and the switch 62 are at positions corresponding to the home position center C1 and the touchpad center C2, That is, the button 61 and the switch 62 are on an extension line of the home position center C1 and the touchpad center C2.

As shown in FIGS, 4 and 5, the switch 62 is directly mounted on the membrane 43 in the flat portion 41. The switch 62 is, for example, a dome switch and can generate a click feeling.

As shown in FIG. 6, the membrane 43 includes a contact 63 corresponding to the switch 62. The wiring pattern 53 is connected to the contact 63. The switch 62 is electrically connected to the main board 6 through the membrane 43 of the keyboard 10. That is, a signal input to the switch 62 is input to the main board 6 through the membrane 43.

Next, the wiring pattern 53 will be described in detail with reference to FIG. FIG. 6 shows the membrane 43 reversed in the vertical and horizontal directions. A first opening portion 71, a second opening portion 72, and a third opening portion 73 are provided below the space key 32. For example, supporting mechanisms (not shown) for supporting the space key 32 is attached to the first opening portion 71, the second opening portion 72, and the third opening portion 73

The first opening portion 71 faces the center portion of the space key 32. The contact 52 corresponding to the space key 32 is provided in the first opening portion 71. The second opening portion 72 faces a left end portion 32a (first end portion) of the space key 32. The third opening portion 73 faces a right end portion 32b (second end portion) of the space key 32.

A first passage portion 74 is between the first opening portion 71 and the second opening portion 72. A second passage portion 75 is between the first opening portion 71 and the third opening portion 73. A relatively large space below the space key 32 is used as the first passage portion 74 and the second passage portion 75, in which the wiring patterns 53 extend.

The FFC 55 is connected to the second passage portion 75. Most of the wiring patterns 53 extend in the second passage portion 75 and are bundled into the FFC 55 in the second passage portion 75.

The first passage portion 74 is adjacent to the switch 62. As shown in FIG. 6, the wiring patterns 53 are also provided in the flat portion 41. Since the opening portions 51 corresponding to the keys 31, 32, 33, 34, 35, 36, and 37 are not provided in the flat portion 41, the flat portion 41 makes it relatively easy to ensure an area for the wiring layout ii the membrane 43. The wiring patterns 53 in the flat portion 41 extend substantially in a straight line along the outline of the flat portion 41 (that is, the front end portion of the keyboard 10).

The wiring patterns 53 in the flat portion 41 extend from the left end portion of the keyboard 10 to the switch 62, are curved in a region 77 adjacent to the switch 62, and then extend to the first passage portion 74. That is, the wiring patterns 53 in the flat portion 41 are curved so as to avoid the switch 62 and extend below the space key 32. The “region adjacent to the switch” means, for example, a region between the space key 32 and the palmrest 22 (touchpad 21).

As shown in FIG. 3, for example, the button 61 is smaller than each of the keys 31, 32, 33, 34, 35, 36, and 37 of the keyboard 10 and has a shape different from those of the keys 31, 32, 33, 34, 35, 36, and 37. The frame 45 includes an opening portion 81 in the flat portion 41. The button 61 is in the opening portion 81. In this way, the button 61 has a height different from those of, for example, the space key 32 or the other keys 33, 34, 35, 36, and 37. For example, the height of the upper surface 61a of the button 61 is substantially equal to that of the upper surface 45a of the frame 45. That is, the upper surface 61a of the button 61 is flush with the upper surface 45a of the flat frame 45.

According to the electronic apparatus 1 having the above-mentioned structure, it is possible to improve the outward appearance of the electronic apparatus 1. That is, in this embodiment, the electronic apparatus 1 includes the keyboard 10 including the flat portion 41 between the space key 32 and the palmrest 22 on the side of the cursor key 35. The keyboard 10 has a substantially rectangular shape without any abnormal outward form (a convex portion in the vicinity of the cursor keys). Therefore, it is possible to improve the designability of the keyboard 10.

In this embodiment, the button 61 and the switch 62 for turning on or off the touchpad 21 are provided in the flat portion 41 (empty space) of the keyboard 10 formed by the keyboard 10 having a substantially rectangular shape. Therefore, the number of buttons exposed at out of the keyboard 10 is reduced, which contributes to improving the designability of the keyboard 10.

Since the button 61 for turning on or off the touchpad 21 is provided on the keyboard 10, the button 61 is close to the keys of the keyboard 10. For example, the user can push the button 61 with the thumb while operating the keys of the keyboard 10. In this way, it is possible to improve the operability or convenience of the button 61.

As in this embodiment, when the keyboard and the button for turning on or off the touchpad are integrally formed, it is possible to reduce cost and space. Specifically, it is considered that a small board is arranged between the keyboard and the touchpad and a switch for turning on or off the touchpad is mounted on the small board. However, in this case, it is necessary to separately provide a small board or a structure (for example, a harness or an FFC) for connecting the small board and the main board.

In contrast, in this embodiment, the switch 62 for turning on or off the touchpad 21 is provided on the membrane 43 of the keyboard 10. Therefore, it is possible to substantially omit the small board or the connection structure. That is, a new additional member or a special structure for mounting the switch 62 for turning on or off the touchpad 21 is not needed. Therefore, it is possible to reduce the thickness, weight, and manufacturing costs of the electronic apparatus 1 and improve the quality of the electronic apparatus 1.

The opening portions 51 corresponding to the keys 31, 32, 33, 34, 35, 36, and 37 are not provided in the flat portion 41, which makes it easy to lay out the wiring pattern. That is, the keyboard 10 having a substantially rectangular shape makes it easy to lay out the wiring pattern.

In this embodiment, the switch 62 is adjacent to the space key 32. In this embodiment, the wiring pattern 53 extending to the switch 62 in the flat portion 41 is curved in the region 77 adjacent to the switch 62 and then extends below the space key 32. The space key 32 is longer than the other keys and it is easy to ensure an area for arranging the wiring pattern 53 below the space key 32.

In this embodiment, since the switch 62 is adjacent to the space key 32, it is possible to effectively use a space below the space key 32 Specifically, the wiring pattern 53 extending along the key row 39 in the flat portion 41 is curved toward the lower side of the space key 32 and then extends below the space key 32. Therefore, a region for mounting the switch 62 is provided in the flat portion 41. In this way, it is possible to mount the switch 62 in the flat portion 41 and connect the wiring pattern 53 extending along the key row 39 in the flat portion 41 to the ETC 55 without any interference with the switch 62.

Since the shape or height of the button 61 for turning on or off the touchpad 21 is different from that of the space key 32 or other keys, it is possible to diminish the wrong button from being pushed and improve operability. When the button 61 is in the opening portion 81 of the frame 45 the keyboard 10 and the upper surface 61a of the button 61 flush with the upper surface 45a of the frame 45, the button 61 does not protrude from the frame 45. Therefore, it is possible to further improve the outward appearance of the keyboard and diminish the wrong button from being pushed.

In this embodiment, in the frame 45, the protrusions 60 fused and fixed to the metal plate 44 are also in the flat portion 41. That is, the use of the flat portion 41 makes possible to increase the number of protrusions 60 fused and fixed to the metal plate 44. Therefore, the strength of the keyboard 10 is further increased.

In this embodiment, the switch 62 is between the space key 32 and the touchpad 21. The switch 62 is at a position corresponding to the home position center C1 of the keyboard 10. The switch 62 is at a position corresponding to the touchpad center C2 of the touchpad 21. According to this structure, since the hand of the user who operates the keyboard 10 is naturally close to the button 61 for turning on or off the touchpad, the operability of the keyboard is improved.

### Second Embodiment

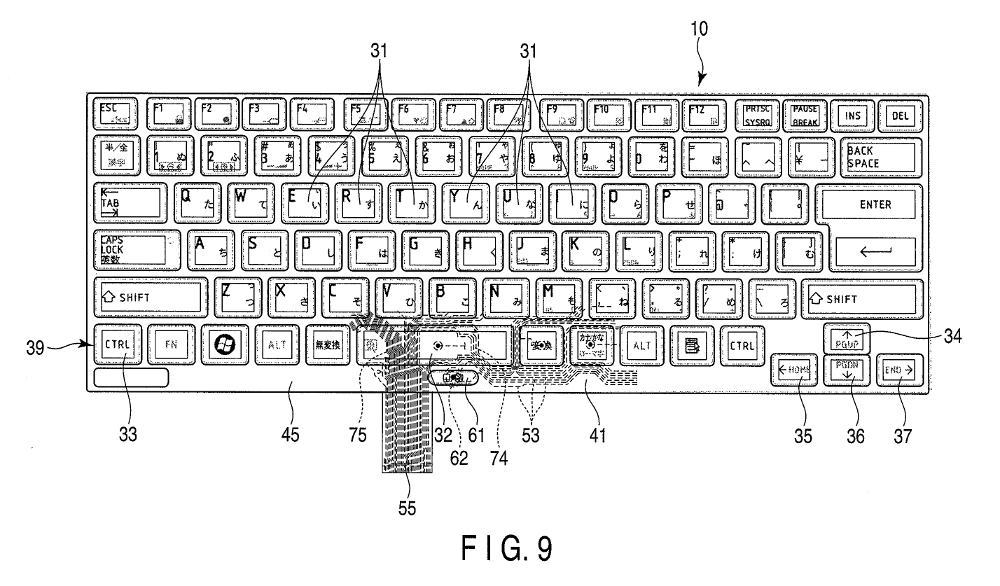

Next, an electronic apparatus 1 according to a second embodiment will be described with reference to FIG. 9. In the second embodiment, components having the same or similar functions as those of the first embodiment are denoted by the same reference numerals and a description thereof will not be repeated. In addition, structures other than the following structures are the same as those in the first embodiment.

FIG. 9 shows a keyboard 10 according to this embodiment. The keyboard 10 according to this embodiment is a JIS keyboard and corresponds to the input of Japanese characters. In the keyboard 10 according to this embodiment, wiring patterns 53 extend in a space below the space key 32 so as to avoid a switch 62.

According to the electronic apparatus 1 having the above-mentioned structure, similar to the first embodiment, is possible to obtain the effect of improving the outward appearance and other effects.

Embodiments are not limited to the above-described embodiments, but the components of the above-described embodiments may be changed without departing from the scope and spirit of the invention, In addition, a plurality of components according to the above-described embodiments may be appropriately combined with each other to form various structures. For example, some of the components according to the above-described embodiments may be removed. The components according to different embodiments may be appropriately combined with each other.

For example, the module controlled by the button 61 and the switch 62 is not limited to the touchpad 21, but other modules may be controlled by the button 61 and the switch 62. The wiring pattern 53 does not necessarily extend below the space key 32 The keyboard 10 is not limited to the tile keyboard. The height of the upper surface 61a of the button 61 may be different from that of the upper surface 45a of the frame 45 of the keyboard 10. The button 61 and the switch 62 may be in a portion other than between the space key 32 and the touchpad 21. The button 61 and the switch 62 may deviate from the home position center C1 of the keyboard 10 or the touchpad center C2 of the touchpad 21.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall, within the scope and spirit of the inventions.

What is claimed is:

1. An electronic apparatus comprising:
a housing comprising a palmrest, a touchpad, and a keyboard, wherein the keyboard comprises
a space key;
a cursor key located closer than the space key to the palmrest;
a flat portion between the space key and the touchpad, wherein one side of the flat portion is bounded by the cursor key; and
a membrane;
a switch located in the flat portion and mounted on the membrane, wherein the switch is configured to turn the touchpad on and off; and
wherein the membrane comprises a wiring pattern, the wiring pattern extending to the switch in the flat portion, curving in a region adjacent to the switch, and extending below the space key,

2. The electronic apparatus of claim 1, wherein the keyboard further comprises a button located above the switch, the button having a height different from that of the space key.

3. The electronic apparatus of claim 2, wherein:
the keyboard further comprises a frame covering the membrane, the frame comprising an opening portion and an upper surface; and
the button is located in the opening portion and comprises an upper surface having a height. substantially equal to that of the upper surface of the frame.

4. electronic apparatus of claim 3, wherein:
the keyboard further comprises a metal plate covering a lower surface of the membrane, the metal plate configured to include a hole; and
the frame further comprises a protrusion inserted into the hole of the metal plate and affixed to the metal plate, in the flat portion.

5. The electronic apparatus of claim 1, wherein the switch is located between the space key and the touchpad.

6. The electronic apparatus of claim 1, wherein the switch is located at a home position center of the keyboard.

7. The electronic apparatus of claim 1, wherein the switch is located at a touchpad center of the touchpad.

8. An electronic apparatus comprising
a housing comprising a palmrest, a module, and a keyboard, wherein the keyboard comprises
a space key;
a cursor key located closer than the space key to the palmrest;
a flat portion between the space key and the palmrest wherein one side of the flat portion is bounded by the cursor key; and
a membrane; and
a switch located in the flat portion and mounted on the membrane, wherein the switch is configured to turn the module on and off

9. An electronic apparatus comprising
a housing comprising a palmrest, and a keyboard, wherein the keyboard comprises:
a space key; and
a cursor key located closer than the space key to the palmrest; and
a switch located in a region of the keyboard surrounded by the space key, the cursor key, and the palmrest.
